(19) United States
(12) Patent Application Publication
(10) Pub. No.: US 2017/0102831 A1
(43) Pub. Date: Apr. 13, 2017

(54) SYSTEM AND METHOD FOR DISPLAYING CONTENT OBJECTS

(71) Applicant: Xpire, LLC, Dallas, TX (US)

(72) Inventor: Jesse Stauffer, Dallas, TX (US)

(21) Appl. No.: 14/880,825

(22) Filed: Oct. 12, 2015

(51) Int. Cl. G06F 3/0481; H04L 29/08

(52) U.S. Cl. CPC G06F 3/0481; H04L 67/02; H04L 67/2852

(57) ABSTRACT

A system and method may be provided for displaying a content object to a user. A difference between a real time and an origination time of the content object may be calculated. When the difference exceeds a predetermined time frame in which the user may desire a content object to be available for display, an application or a website may be prompted to remove the content object from content objects available for display in the application or on the website. Additionally, the method and the system may provide calculating a social score for each content object that may be displayed. An unfavorable social score may prompt the application or the website to warn the user before the user may be permitted to share the displayed content object with other users.

### FIELD OF THE DISCLOSURE

The present disclosure relates generally to integrating content objects. In particular, the disclosure relates to a method for displaying content objects and a system for displaying content objects.

### BACKGROUND

Methods for displaying content objects and systems for displaying content objects typically provide integration or a mashup of content objects (e.g., articles, feeds, posts, e-mails, and text messages) originating from different source objects (e.g., social media providers, news networks, communication outlets, e-mail service providers, and messaging service providers). These methods and systems for displaying content objects may assist users in organizing content objects using a single application or website. Additionally, these methods and systems for displaying content objects may provide ephemeral content objects that are automatically deleted after a predetermined time frame. However, there remains a need for tracking recent and unread content objects posted within a predetermined time frame, and calculating a score for these content objects to determine whether they are appropriate to share with other users.

### SUMMARY

Embodiments of the present disclosure may provide a method of displaying a content object to a user. The method may include the step of calculating a difference between a real time and an origination time of the content object. The difference between the real time and the origination time of the content object may be continuously calculated. The method may include the step of determining whether the difference between the real time and the origination time is less than a predetermined time frame. When the difference between the real time and the origination time of the content object is equal to or exceeds the predetermined time frame, the content object may be removed from content objects available for display in an application or on a website. Further, the method may provide the step of determining whether the content object was previously viewed. When a content object was previously viewed, the content object may be removed from content objects that may be available for display in the application or on the website. The method may provide the step of displaying the content object in the application or on the website when the difference between the real time and the origination time of the content object may be less than the predetermined time frame, and when the content object was not previously viewed. The method may further provide the step of assigning an identifier to a content object that may have been displayed, and the identifier may be stored in a cache. The method may provide the step of calculating a social score for the content object that may have been displayed. An unfavorable social score may prompt the application or the website to warn the user before the user may be permitted to share the content object that may have been displayed. The method may further provide the step of emptying the cache after the predetermined time frame. The method may further comprise detecting an end of a content set after emptying the cache, wherein the content set may include a plurality of content objects, and returning the user to the step of accessing the content provider from the application or the website. The method also may include filtering the content object based on filter criteria, clustering the content object based on cluster criteria and/or sorting and organizing the content object based on criteria specified by the user.

A system may display a content object to a user and may include an application or a website that may be provided to access a content provider. The system may further include a source object that may be selected from the content provider. Further, the system may provide a content object that may be retrieved from the source object. The system may provide a calculation module that may be integrated with a cache. The calculation module may be provided to continuously calculate a difference between a real time and an origination time of the content object. The system may include a display module that may be provided to display the content object in the application or on the website when the difference between the real time and the origination time of the content object may be less than a predetermined time frame, and when the content object has not been previously viewed. The cache may be provided to assign an identifier to a displayed content object, and the identifier may be stored in the cache. The calculation module may calculate a social score for the displayed content object, wherein an unfavorable social score may prompt the application or the website to warn the user before the user is permitted to share the displayed content object. The system may further comprise a content set, and the content set may include a plurality of content objects. The system may empty a cache and may detect an end of the content set. The system may comprise a filter module that may be provided to filter the content object based on a filter criteria. The system may comprise a cluster module that may be provided to cluster the content object based on a cluster criteria. The system may further comprise a sort and organize module that may be provided to sort and organize the content object based on criteria specified by the user.

A non-transitory computer readable medium may be provided to execute a process for displaying a content object to a user. The process may include calculating a difference between a real time and an origination time of the content object, and may continuously calculate the difference between the real time and the origination time of the content object. The process may include determining whether the difference between the real time and the origination time is less than a predetermined time frame. The process may further include determining whether the content object was previously viewed. Additionally, the process may include displaying the content object in the application or on the website when the difference between the real time and the origination time of the content object is less than the predetermined time frame, and when the content object was not previously viewed. The process may further include assigning an identifier to a displayed content object, and the identifier may be stored in a cache. The process may include calculating a social score for the displayed content object, and may provide emptying the cache after the predetermined time frame.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1A depicts a method of displaying a content object according to an embodiment of the present disclosure;

FIG. 1B further depicts the method of displaying a content object, as depicted in FIG. 1A, according to an embodiment of the present disclosure;

FIG. 2 depicts a system for displaying a content object according to an embodiment of the present disclosure;

FIG. 3 depicts a device displaying a plurality of source objects according to an embodiment of the present disclosure; and

FIG. 4 depicts a device displaying a single content object according to an embodiment of the present disclosure.

### DETAILED DESCRIPTION

Embodiments of the present disclosure may generally provide a method and a system for displaying one or more content objects to a user. In order for a content object to be displayed in an application or on a website, the content object may be identified as recent and not previously viewed.

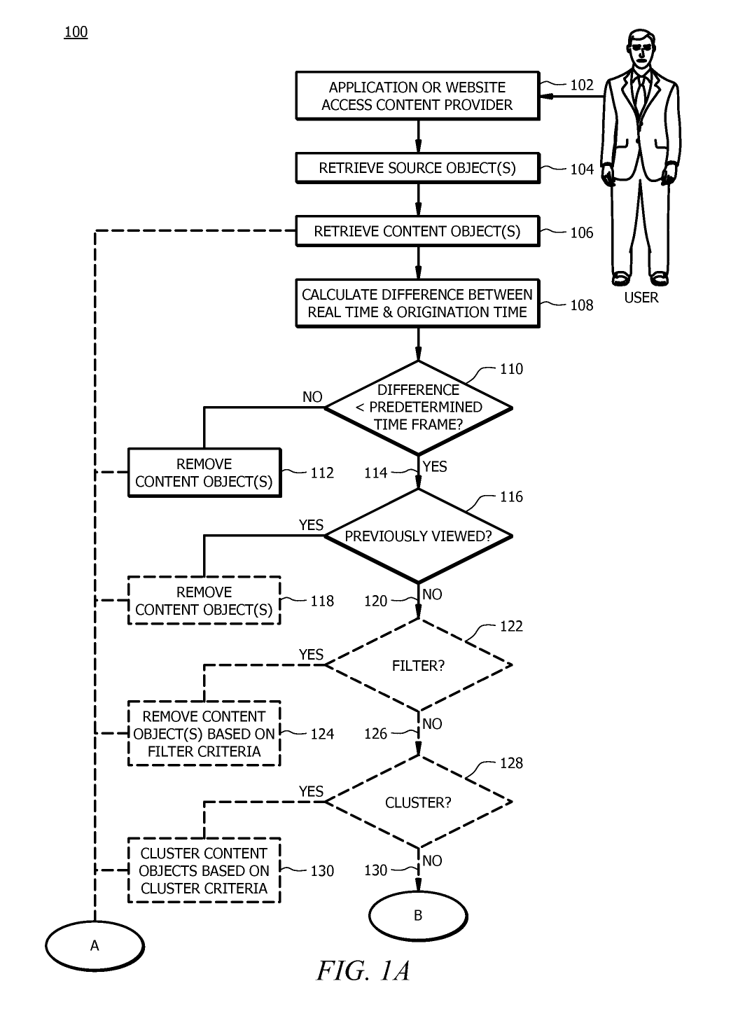

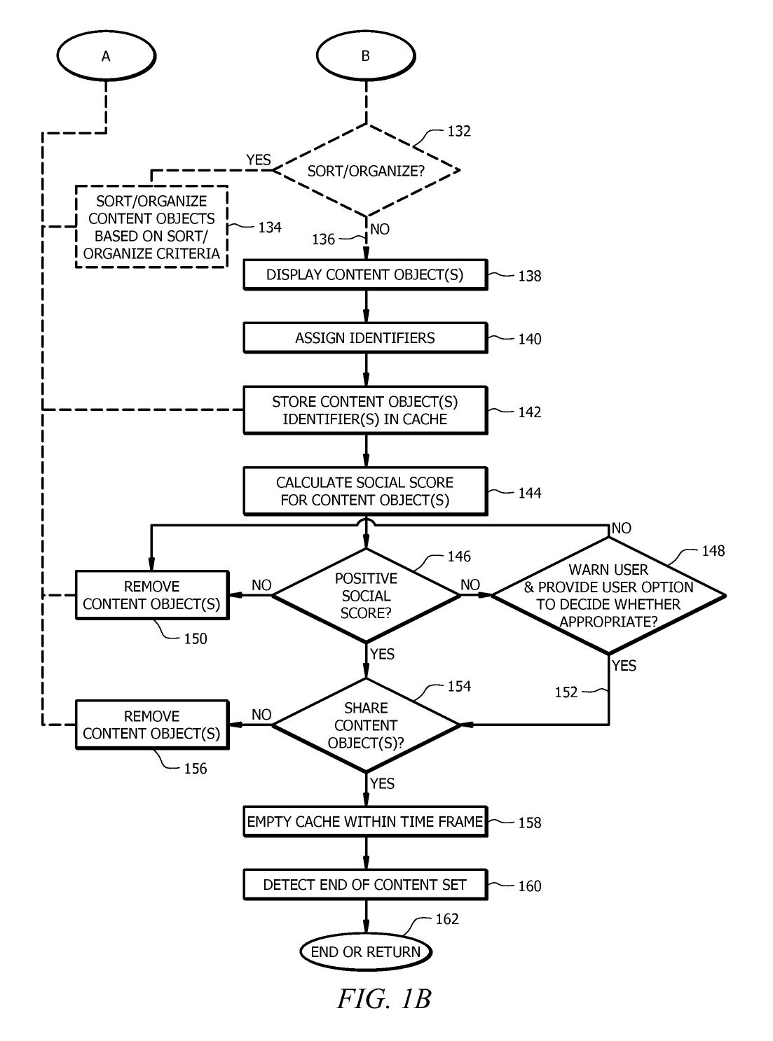

FIG. 1A depicts method 100 that may display a content object, according to an embodiment of the present disclosure. As depicted in FIG. 1A, a user may open an application or a website which may provide access to a content provider (operation 102). Content providers may include, but are not limited to, social media outlets, news publications, and communication outlets. For example, a content provider may be Twitter®, Facebook®, and/or Cable News Network® (CNN®). As depicted in FIG. 1A, the method of displaying a content object to a user may provide the step of retrieving one or more source objects from a content provider (operation 104). For example, a source object, such as a Twitter user, may be retrieved from a content provider, such as Twitter. It should be appreciated a source object may be any user associated with a content provider. For example, a source object may be a Twitter user and/or Twitter itself (e.g., when Twitter sends tweets), a Facebook user and/or Facebook itself (e.g., when Facebook posts content), and/or a CNN journalist. It should be appreciated a content provider may be selected by a user upon launching an application or a website. It should also be appreciated a content provider may be preset and may automatically be displayed in an application or on a website. It should be appreciated there may be embodiments where a content provider may not be preset into an application or on a website without departing from the present disclosure.

As shown in FIG. 1A according to an embodiment of the present disclosure, the method of displaying a content object to a user may provide the step of retrieving one or more content objects from one or more source objects (operation 106). A content object may be retrieved from a source object (operation 106) by determining whether the source object includes any content objects. For example, user A, a source object, may be selected from Twitter, a content provider. The method may provide the step of determining whether user A may have “tweeted” a tweet (a content object). It should be appreciated a content object may include, but is not limited to, an electronic mail (e-mail) message, a short message service (SMS) message, a tweet, a Facebook status update, a Facebook post, and/or a CNN article. It should further be appreciated a content object may include, but is not limited to, text, images, and/or video. It should be appreciated a maximum number of content objects may be included in a content set. For example, a maximum number of 5,000 Facebook statuses may be included in a content set. Further, it should be appreciated a content set may include content objects retrieved over a predetermined time frame, as further described below, from any source object and/or content provider. For example, all tweets, Facebook statuses, and CNN articles that may originate within a specific thirty-minute time frame may be considered a content set. It should also be appreciated a content set may include content objects that may be retrieved from any source object and/or any content provider without departing from the present disclosure. For example, a content set may include all tweets retrieved from the same Twitter user. As another example, a content set may include all Twitter tweets and/or Facebook statuses that may be retrieved from the same user on Twitter and on Facebook.

According to an embodiment of the present disclosure as shown in FIG. 1A, after retrieving a content object, the method may provide the step of calculating a difference between a real time and an origination time of a content object (operation 108). The real time may be a current local time when an application or a website may retrieve a content object. The origination time of a content object may be the local time when a content object may have originally been posted, published, or uploaded by a source object to a content provider. For example, a Twitter user, a source object, may reside in the Central Time Zone and may open an application or a website to access Twitter, a content provider. This user may retrieve a tweet, a content object, at 10:00 p.m. Central Standard Time (CST). However, the tweet may have been “tweeted” for the first time at 6:00 p.m. Eastern Standard Time (EST), the origination time of the content object. As such, the real time may be the time that the Twitter user retrieved the tweet, 10:00 pm CST, and the origination time of the tweet may be 5:00 p.m. CST. Consequently, the difference between 10:00 p.m. CST (the real time) and 5:00 p.m. CST/6:00 p.m. EST (the origination time of the content object), may be calculated as five hours. Further, according to an embodiment of the present disclosure, the difference between the real time and the origination time of the content object may be compared to a predetermined time frame (operation 110), as further described below.

As shown in FIG. 1A according to an embodiment of the present disclosure, the method of displaying a content object to a user may provide the step of determining whether the difference between the real time and the origination time is less than the predetermined time frame (operation 110). The predetermined time frame may be the amount of time a user desires a content object to be available for display in the application or on the website. For example, a predetermined time frame may be 24 hours, and a user may not desire to view any content objects that may have originated over a predetermined time frame greater than or equal to 24 hours. Here, if the difference between a real time and an origination time of the content object is greater than or equal to 24 hours, the difference may exceed the predetermined time frame (110—No). When the difference may exceed the predetermined time frame (110—No), for example, when a content object exists for 32 hours compared to a 24-hour predetermined time frame, the method may provide the step of removing the content object with an expired predetermined time frame from content objects available for display in the application or on the website (operation 112). However, when the difference between the real time and the origination time of the content object does not exceed a predetermined time frame (110—Yes), for example, when a content object may exist for 20 hours compared to a 24-hour predetermined time frame, the content object may be retained with content objects that may be available for display in the application or on the website. Consequently, a content object that may originate for a period of time less than the predetermined time frame (110—Yes) may be displayed in the application or on the website (operation 138—FIG. 1B). The difference between the real time and the origination time of a content object may be continuously calculated. Continuously calculating the difference between the real time and the origination time of a content object may include frequently calculating the difference, and as such, content objects that may be displayed may always be up-to-date. Further, continuously calculating the difference between the real time and the origination time of content object may ensure the user is not shown duplicate content objects or different content objects including the same text, images, and/or video. It should be appreciated that continuously calculating the difference between the real time and the origination time of a content object may provide calculating the difference to a degree of precision that may be desired by the user (e.g. including, but not limited to, calculating the difference between the real time and the origination time every second, every 30 seconds, or every minute). It should be appreciated that the difference between the real time and the origination time of a content object may be automatically and continuously calculated to at least one predetermined degree of precision that may not require user input.

As depicted in FIG. 1A according to an embodiment of the present disclosure, the method may provide the step of determining whether a content object may have been previously viewed (operation 116). When the content object has been previously viewed (116—Yes), the method may provide the step of removing the previously viewed content object from content objects that may be available for display in an application or on a website (operation 118). Alternatively, a content object that may not have been previously viewed (116—No) may be retained with content objects available for display in the application or on the website. Further, the method may provide the step of prompting an application or a website to display a content object in the application or on the website (operation 138—FIG. 1B) when the content object may not have been previously viewed. It should be appreciated the method may provide the step of removing a content object that may have been previously viewed from content objects that may be available for display in the application or on the website (operation 118), regardless the difference between the real time and the origination time of a content object. It should be appreciated if a user desires, a previously viewed content object (116—Yes) may be retained with content objects available for display in the application or on the website without departing from the present disclosure.

As depicted in FIGS. 1A and 1B according to an embodiment of the present disclosure, following the step of determining whether a content object may have been previously viewed (operation 116), the method may provide the step of displaying the content object (operation 138) or may provide the step(s) of any combination of filtering a content object (operation 122), clustering a content object (operation 128), and sorting and organizing a content object (operation 132) prior to displaying the content object (operation 138). It should be appreciated that “A” and “B”, as shown in FIGS. 1A and 1B, illustrate continuing the method from FIG. 1A to FIG. 1B. It should be appreciated content objects, source objects, and/or content providers may be filtered, clustered, and sorted and organized without departing from the present disclosure. The method may provide the step of filtering content objects (operation 122), and filtering may be based on any filter criteria that may include, but may not be limited to, a range of dates in which a content object may have originated, a particular topic that may be related to a content object, and duplicate content that may be included in a content object. When the content object requires filtering (122—Yes), the method may provide the step of removing a content object that meets filter criteria desired by the user (i.e., needs to be filtered and removed) (operation 124). It should be appreciated that filtering content objects (122—Yes) may provide the step of returning the filtered content objects to be clustered (operation 128), sorted and organized (operation 132), and/or displayed in an application or on a website (operation 138) without departing from the present disclosure. When a content object does not meet filter criteria (122—No) (i.e., does not need to be filtered), the content object may be retained with content objects available for display in the application or on the website. It should be appreciated that duplicate content may be filtered from the same source object. For example, if source object A posts a content object and then posts the same content object a second time, the content object posted the second time may be filtered out of content objects available for display, so that the user may not view duplicate content. It should also be appreciated that if different source objects post duplicate content that may be included in the same media type including, but not limited to, photos, video, and new links, duplicate content may be filtered out. For example, if source object A posts a photo and source object B posts the exact same photo, the photo posted by source object B may be filtered out of content objects available for display.

As shown in FIG. 1A according an embodiment of the present disclosure, the method may provide the step of clustering a content object (operation 128) and clustering may be based on cluster criteria that may include, but may not be limited to, clustering a content object with other content objects that may have been retrieved from the same source object(s). For example, two tweets published by the same Twitter user may be clustered together. When the content object requires clustering (128—Yes), the method may provide the step of removing a content object that meets cluster criteria (operation 130) and/or may provide the step of returning a content object that meets cluster criteria to be sorted and organized (operation 132) and/or displayed in an application or on a website (operation 138) without departing from the present disclosure. When a content object does not meet cluster criteria (128—No), the content object may be retained with content objects available for display in the application or on the website. It should be appreciated that cluster criteria may include clustering source objects that may have been retrieved from the same content provider without departing from the present disclosure.

As shown in FIG. 1B according to an embodiment of the present disclosure, the method may provide the step of sorting and organizing objects according to criteria specified by a user (operation 132) including, but not limited to, displaying content objects in alphabetical order, displaying content objects according to the time the content objects were posted or published, displaying read content objects, displaying unread content objects, and displaying the most popular content objects. When the content object meets criteria specified by a user and requires sorting and/or organizing (132—Yes), the content object may be removed from content objects available for display in an application or on a website (operation 134). It should be appreciated that if a plurality of content objects meet criteria specified by the user (132—Yes) (i.e., the plurality of content objects need to be sorted and/or organized), the method may provide the step of removing some content objects (operation 134) from the plurality of content objects, and may return other content objects from the plurality of content objects to method 100. It should also be appreciated that the user may select which of the plurality of content objects may be displayed in an application or on a website (operation 138) without departing from the present disclosure. If a content object does not meet criteria specified by a user (132—No) (i.e., does not need to be sorted/organized), the content object may be retained with content objects available for display in the application or on the website.

According to an embodiment of the present disclosure, as shown in FIG. 1B, the method may provide the step of assigning one or more object identifiers to a content object (operation 140). It should be appreciated an object identifier may be assigned to content objects, source objects, content providers, and any combination of these objects and providers according to embodiments of the present disclosure. To limit storage utilization, the method may provide the step of refactoring object identifiers by deleting object identifiers that may correspond to old content objects and/or that may correspond to content objects that may have been available for a time frame longer than the predetermined time frame. Refactoring of object identifiers may be performed using an algorithm that may be executed after launching the application or the website. It should be appreciated that the algorithm may iterate through identifier-time pairs that may be saved in the cache. It should further be appreciated that the algorithm may perform a check to determine whether the predetermined time frame may have elapsed since identifier-time pair data may have been saved. It should be appreciated that when the predetermined time frame has elapsed since identifier-time pair data may have been saved, the identifier-time pair may be deleted from the cache. For example, if the difference between the saved time of the identifier-time pair (i.e., the origination time of the content object) and the real time of the identifier-time pair is greater than or equal to the predetermined time frame, then the content object may be removed from content objects available for display in the application or on the website. It should be appreciated the user may determine which content objects are considered old content objects. It should be appreciated the method may provide the step of refactoring object identifiers that may be considered irrelevant to the users' profile, preferences, and interests. For example, an irrelevant content object may be a tweet related to a sale for pet toys when the user does not own a pet. Further, it should be appreciated the method may provide the step of saving or storing content objects for future deletion by referencing the object identifiers that may be saved in a cache, as opposed to saving content objects for future display (operation 142).

As shown in FIG. 1B, according to an embodiment of the present disclosure, the method may provide the step of calculating a content object's social score (operation 144). A social score may determine whether a content object may be appropriate to post for other users to view. A social score may be calculated by determining a percentage of text, images, and/or video within the content object that may be matched with a database of inappropriate content. It should be appreciated that the content object may be matched with inappropriate content including, but not limited to, text, images, and/or video. It should be appreciated that inappropriate text may be assigned a risk weight, and a scan of a content object may be performed to calculate a sum of risk weights. It should further be appreciated that the sum of risk weights may be used to calculate a percentage of inappropriate content included in the content object. It should also be appreciated a numeric risk factor may be assigned to the percentage of inappropriate text, and the number risk factor may include, but may not be limited to, numerals 0 through 100. It should be appreciated that numerals 0 through 100 may be converted to a grade (i.e., a letter including, but not limited to, A+, C, and F). The method may provide the step of determining whether the social score is a favorable social score (operation 146). When an unfavorable social score may be calculated for a content object, the method may provide the user with an automatic warning that the content object may be inappropriate (operation 148). This step also may include allowing the user to decide whether the content object may be removed from content objects that may be available for display in the application or on the website (operation 148). When a favorable social score is not calculated, the method may provide the step of allowing the user to remove the content object from content objects that may be available to be displayed in an application or on a website (operation 150). It should be appreciated the method may provide the step of automatically removing a content object when a favorable social score may not be calculated in some embodiments of the present disclosure. Further, the method may provide the step of allowing the user to share the content object with other users, even if the social score is not favorable (operation 152). When the social score of a content object is favorable (146—Yes), the method may provide the step of allowing the user to decide whether the content object may be removed as a content object available for display in the application or on the website (operation 156) or may be retained to be shared with other users (154—Yes) and may remain a content object available for display in an application or on a website until a predetermined time frame expires. When the predetermined time frame expires, the cache may be emptied (operation 158) and the content object may no longer be displayed and/or available to be shared. Further, as the cache may be referenced to reload the content object, the user will not be shown a duplicate content object. It should be appreciated that calculating a content object's social score may provide the step of automatically scanning the content object for predetermined inappropriate content. For example, a social score of an “A+” may be calculated for a content object that may not include inappropriate content. However, a social score of an “F” may be calculated for a content object that may include a large percentage of inappropriate content. It should be appreciated the method may provide the step of automatically deleting content objects that may be assigned an unfavorable social score. It should also be appreciated the method may provide the step of automatically posting content objects that may be assigned a favorable social score. It should be appreciated an unfavorable social score may be indicated by a poor letter grade, a low numerical identifier, or any identifier provided after calculating a social score. It should further be appreciated the method may provide the step of adding desired text, images, and/or video that may be compared to text, images, and/or video contained in the content object. It should be appreciated calculating a social score for a content object may enable a user to become more appealing to an individual or a group of individuals including, but not limited to, employers, in-laws, friends, parents, and the user's community.

As shown in FIG. 1B, according to an embodiment of the present disclosure, the method may provide the step of emptying a cache within a predetermined time frame (operation 158). It should be appreciated the method may provide the step of emptying the cache upon demand and/or within a time frame specified by the user without departing from the present disclosure. It should be appreciated the method may provide the step of removing a content object from the content set, after the content object is displayed and read by the user. The method may further provide the step of detecting the end of a content set (operation 160). Further, the method may provide the step of automatically returning the user to the application or website to access a content provider (operation 162).

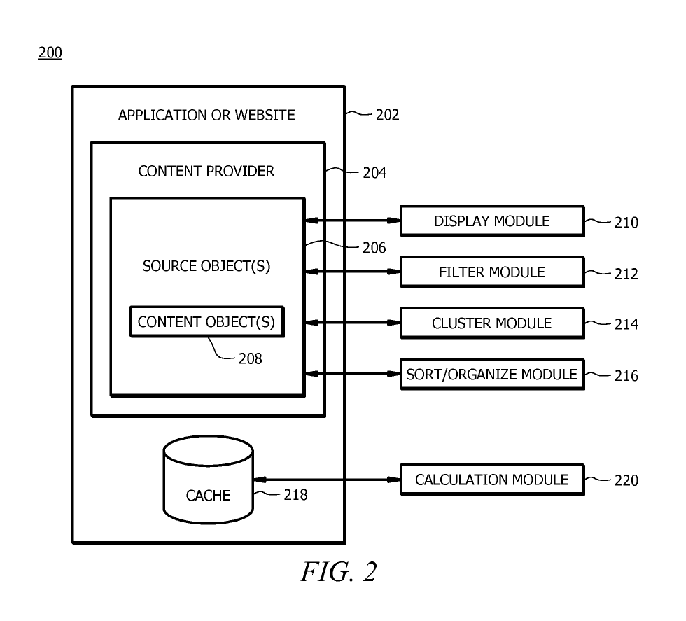

FIG. 2 depicts system 200 for displaying one or more content objects 208 to a user, according to an embodiment of the present disclosure. System 200 may provide application or website 202 that may access content provider 204. It should be appreciated content provider 204 may be selected by a user and may be preset in the application or website provided. It should be appreciated content provider 204 may automatically be displayed in application or on website 202. It should further be appreciated that there may be embodiments where content provider 204 may not be preset into application or on website 202, and content provider 204 may be selected after application or website 202 may be launched and accessed without departing from the present disclosure. It should be appreciated content providers may include, but are not limited to, social media outlets, news publications, and communication outlets. For example, content provider 204 may be Twitter, Facebook, and/or CNN. As depicted in FIG. 2, system 200 for displaying content object 208 to a user may retrieve one or more source objects 206 from content provider 204. For example, source object 206, such as a Twitter user, may be retrieved from content provider 204, such as Twitter. It should be appreciated source object 206 may be any user associated with content provider 204. For example, source object 206 may be a Twitter user and/or Twitter itself (e.g., when Twitter sends tweets), a Facebook user and/or Facebook itself (e.g., when Facebook posts content), and/or a CNN journalist.

As shown in FIG. 2 according to an embodiment of the present disclosure, system 200 for displaying content object 208 to a user may retrieve one or more content objects 208 from one or more source objects 206. Content object 208 may be retrieved from source object 206 by determining whether source object 206 includes any content objects 208. For example, user A (source object 206) may be selected from Twitter (content provider 204). System 200 for displaying content object 208 to a user may provide determining whether user A has “tweeted” any tweets or content objects 208. It should be appreciated content object 208 may include, but is not limited to, an electronic mail (e-mail) message, a short message service (SMS) message, a tweet, a Facebook status update, a Facebook post, and/or a CNN article. It should further be appreciated content object 208 may include, but is not limited to, text, images, and/or video. It should be appreciated a maximum number of content objects 208 may be included in a content set. For example, a maximum number of 5,000 Facebook statuses may be included in a content set. Further, it should be appreciated a content set may include content objects 208 that may have been retrieved over a predetermined time frame programmed into calculation module 220, as further described below, from any source object 206 and/or content provider 204. For example, all tweets, Facebook statuses, and CNN articles that originate within a specific thirty-minute time frame may be considered a content set. It should also be appreciated a content set may include content objects 208 that may have been retrieved from any source object 206 and/or any content provider 204 without departing from the present disclosure. For example, content set may include all tweets that may have been retrieved from the same Twitter user. As another example, a content set may include all Twitter tweets and/or Facebook statuses that may have been retrieved from the same user on Twitter and Facebook.

According to an embodiment of the present disclosure as shown in FIG. 2, calculation module 220 may be provided to calculate a difference between a real time and an origination time of content object 208. The real time may be a current local time when an application or website 202 may retrieve content object 208. The origination time of content object 208 may be the local time when content object 208 may have been originally posted, published, or uploaded by source object 206 to content provider 204. For example, a Twitter user, source object 206, may reside in the Central Time Zone and may open application or website 202 to access Twitter, content provider 204. This user may retrieve a tweet, content object 208, at 10:00 p.m. Central Standard Time (CST). However, the tweet may have been “tweeted” for the first time at 6:00 p.m. Eastern Standard Time (EST), the origination time of content object 208. As such, the real time may be the time the Twitter user may have retrieved the tweet, 10:00 pm CST, and the origination time of the tweet may be 5:00 p.m. CST. Consequently, the difference between 10:00 p.m. CST (the real time) and 5:00 p.m. CST/6:00 p.m. EST (the origination time of content object 208) may be calculated as five hours. Further, according to an embodiment of the present disclosure, the difference between the real time and the origination time of content object 208 may be compared to a predetermined time frame, as further described below.

As shown in FIG. 2 according to an embodiment of the present disclosure, system 200 for displaying content object 208 to a user may provide calculation module 220 configured to determine whether the difference between the real time and the origination time of content object 208 may be less than the predetermined time frame. The predetermined time frame may be the amount of time a user may desire content object 208 to be available for display in application or on website 202. For example, a predetermined time frame may be 24 hours, and a user may not desire to view any content objects 208 that may exist from a time period greater than or equal to 24 hours. If the difference between a real time and an origination time of content object 208 may be greater than or equal to 24 hours, the difference may exceed the predetermined time frame. When the difference may exceed the predetermined time frame, for example, when content object 208 may exist for 32 hours compared to a 24-hour predetermined time frame, system 200 may remove content object 208 with an expired predetermined time frame from content objects that may be available for display in application or on website 202. However, when the difference between the real time and the origination time of content object 208 does not exceed a predetermined time frame, for example, when content object 208 may exist for 20 hours compared to a 24-hour predetermined time frame, system 200 may retain content object 208 with content objects that may be available for display in application or on website 202. Consequently, content object 208 that may exist for period of time less than the predetermined time frame may be displayed in application or on website 202. Calculation module 220 may be provided to continuously calculate the difference between the real time and the origination time of content object 208. Calculation module 220 may frequently calculate the difference between the real time and the origination time of content object 208, and as such, content objects displayed by display module 210 may always be up-to-date. Further, continuously calculating the difference between the real time and the origination time of content object 208 may ensure the user is not shown duplicate content objects or different content objects including the same text, images, and/or video. It should be appreciated that calculation module 220 may continuously calculate the difference between the real time and the origination time of content object 208 to the degree of precision that may be desired by the user (e.g. including, but not limited to, calculating the difference between the real time and the origination time every second, every 30 seconds, or every minute). It should be appreciated that calculation module 220 may automatically and continuously calculate the difference between the real time and the origination time of content object 208 to at least one predetermined degree of precision that may not require user input.

As depicted in FIG. 2 according to an embodiment of the present disclosure, system 200 for displaying content object 208 may provide determining whether content object 208 may have been previously viewed. System 200 may remove previously viewed content objects from content objects that may be available for display. Alternatively, system 200 may retain content objects 208 that may not have been previously viewed with content objects available for display in application or on website 202. Further, system 200 display content object 208 in application or on website 202 when content object 208 may not have been previously viewed. It should be appreciated system 200 may remove content objects that may have been previously viewed from content objects available for display in application or on website 202, regardless the difference between the real time and the origination time of content object 208. It should be appreciated that system 200 may retain previously viewed content objects with content objects available for display in the application or on the website, if the user desires, without departing from the present disclosure.

As depicted in FIG. 2 according to an embodiment of the present disclosure, system 200 may provide display module 210, filter module 212, cluster module 214, and sort/organize module 216. Display module 210 may be provided to present each content object to a user in an application or on a website. Filter module 212 may filter content objects, cluster module 214 may cluster content objects, and sort and organize module 216 may sort and organize content objects. It should be appreciated content objects 208, source objects 206, and/or content providers 204 may each be filtered, clustered, and sorted and organized without departing from the present disclosure. System 200 may provide filter module 212 to filter content objects 208 based on criteria that may include, but may not be limited to, a range of dates in which content object 208 may have originated, a particular topic that may be related to content object 208, and duplicate content that may be included in content object 208. Filter module 212 may remove content object 208 that meets filter criteria (i.e., needs to be filtered and removed). It should be appreciated that filter module 212 may be provided to return content objects to cluster module 214, sort/organize module 216, and/or display module 210 without departing from the present disclosure. If content object 208 does not meet filter criteria (i.e., does not need to be filtered), system 200 may retain content object 208 with content objects available for display in application or on website 202. It should be appreciated that duplicate content may be filtered from the same source object. For example, if source object A posts a content object and then posts the same content object a second time, the content object posted the second time may be filtered out of content objects available for display, so that the user may not view duplicate content. It should also be appreciated that if different source objects post duplicate content that may be included in the same media type including, but not limited to, photos, video, and new links, duplicate content may be filtered out. For example, if source object A posts a photo and source object B posts the exact same photo, the photo posted by source object B may be filtered out of content objects available for display.

As depicted in FIG. 2 according to an embodiment of the present disclosure, system 200 may provide cluster module 214 to cluster content objects 208. Cluster module 214 may cluster content objects 208 based on cluster criteria that may include, but may not be limited to, clustering a content object with other content objects that may have been retrieved from the same source object(s). For example, cluster module 214 may cluster two tweets that may be published by the same Twitter user. When content object 208 requires clustering, cluster module 214 may remove a content object that meets cluster criteria, and/or may return the content object that meets cluster criteria to sort/organize module 216 and/or display module 210 without departing from the present disclosure. When content object 208 does not meet cluster criteria, content object 208 may be retained with content objects available for display in application or on website 202. It should be appreciated that cluster criteria may include clustering source objects that may have been retrieved from the same content provider without departing from the present disclosure.

As depicted in FIG. 2 according to an embodiment of the present disclosure, system 200 may provide sort/organize module 216 to sort and organize content objects 208 according to criteria specified by a user including, but not limited to, displaying content objects in alphabetical order, displaying content objects according to the time content objects were posted or published, displaying read content objects, displaying unread content objects, and displaying the most popular content objects. When content object 208 meets criteria specified by a user and requires sorting and/or organizing, system 200 may remove content object 208 from content objects available for display in application or on website 202. It should be appreciated that if a plurality of content objects meet criteria specified by the user (i.e., the plurality of content objects need to be sorted and/or organized), sort/organize module 216 may remove some content objects from the plurality of content objects and may return other content objects from the plurality of content objects to system 200 without departing from the present disclosure. It should also be appreciated that the user may select which of the plurality of content objects may be sent to display module 110 without departing from the present disclosure. If content object 208 does not meet criteria specified by a user (i.e., does not need to be sorted/organized), system 200 may retain content object 208 with content objects available for display in application or on website 202.

According to an embodiment of the present disclosure, as shown in FIG. 2, system 200 may assign an object identifier to one or more content objects 208. It should be appreciated that object identifiers may be assigned to content objects 208, source objects 206, content providers 204, and any combination of these objects and providers according to embodiments of the present disclosure. To limit storage utilization, system 200 may refactor object identifiers by deleting object identifiers that may correspond to old content objects or content objects that may have been available longer than the predetermined time frame. Refactoring object identifiers may be performed using an algorithm that may be executed after launching application or website 202. It should be appreciated that the algorithm may iterate through identifier-time pairs that may be saved in cache 218. It should further be appreciated that the algorithm may perform a check to determine whether the predetermined time frame may have elapsed since identifier-time pair data may have been saved. It should be appreciated that when the predetermined time frame has elapsed since identifier-time pair data may have been saved, the identifier-time pair may be deleted from cache 218. For example, if the difference between the saved time of the identifier-time pair (i.e., the origination time of the content object) and the real time of the identifier-time pair is greater than or equal to the predetermined time frame, then content object 208 may be removed from content objects available for display in application or on website 202. It should be appreciated the user may determine which content objects 208 are considered old content objects. It should be appreciated system 200 may refactor object identifiers that may be considered irrelevant to the user's profile, preferences, and interests. For example, an irrelevant content object 208 may be a tweet related to a sale for pet toys when the user does not own a pet. Further, system 200 may save content objects 208 for future deletion by referencing object identifiers that may be saved, as opposed to saving content objects 208 for future display.

As shown in FIG. 2, according to an embodiment of the present disclosure, system 200 may calculate a social score associated with content object 208. In particular, calculation module 220 may be provided to determine whether content object 208 may be appropriate to post for other users to view. A social score may be calculated by determining what percentage of text, images, and/or video within content object 208 may be matched with a database of inappropriate content. It should be appreciated that the content object may be matched with inappropriate content including, but not limited to, text, images, and/or video. It should be appreciated that inappropriate content may be assigned a risk weight, and a scan of content object 208 may be performed to calculate a sum of risk weights. It should further be appreciated that the sum of risk weights may be used to calculate a percentage of inappropriate content included in content object 208. It should also be appreciated a numeric risk factor may be assigned to the percentage of inappropriate content, and the number risk factor may include, but may not be limited to, numerals 0 through 100. It should be appreciated numerals 0 through 100 may be converted to a grade (i.e., a letter including, but not limited to, A+, C, and F). System 200 may determine whether the social score is favorable. When an unfavorable social score may be calculated for content object 208, system may provide the user with an automatic warning that content object 208 may be inappropriate. System 200 may allow the user to decide whether content object 208 may be removed from content objects available for display in application or on website 202. Further, system 200 may allow the user to share content object 208 with other users, even if the social score is not favorable. When the social score of content object 208 is favorable, system 200 may allow the user to decide whether content object 208 may be removed from content objects that may be available for display in application or on website 202. Alternatively, system 200 may allow the user to share content object 208 with other users. It should be appreciated that calculating content object's 208 social score may automatically scan content object 208 for predetermined inappropriate content. For example, a social score of an “A+” may be calculated for content object 208 that may not include inappropriate content. However, a social score of an “F” may be calculated for content object 208 that may include a large percentage of inappropriate content. It should be appreciated system 200 may automatically delete content objects 208 that may be assigned an unfavorable social score. It should also be appreciated system 200 may automatically display content objects 208 that may be assigned a favorable social score. It should be appreciated an unfavorable social score may be indicated by a poor letter grade, a low numerical identifier, or any identifier provided by calculation module 220. It should further be appreciated system 200 may add desired text, images, and/or video that may be compared to text, images, and video contained in content object 208. It should be appreciated that calculating a social score for content object 208 may enable a user to become more appealing to an individual or a group of individuals including, but not limited to, employers, in-laws, friends, parents, and the user's community.

As shown in FIG. 2, according to an embodiment of the present disclosure, cache 218 may be emptied within a predetermined time frame. It should be appreciated system 200 may empty cache 218 upon demand and/or within a time frame desired by the user without departing from the present disclosure. It should be appreciated system 200 may remove content object 208 from the content set, such as after content object 208 may be displayed and read by the user. System 200 may detect the end of a content set, and may automatically return the user to application or website 202 to access content provider 204. It should be appreciated the user may display more than one content object 208 at a time without departing from the present disclosure.

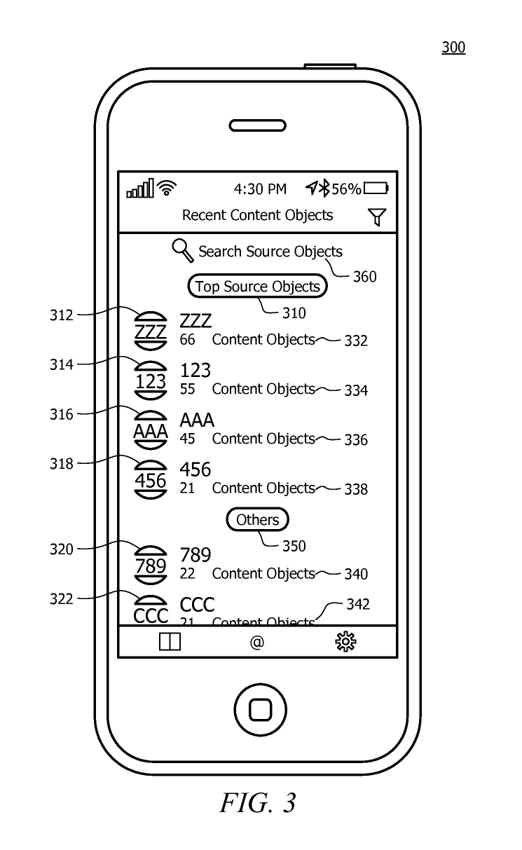

FIG. 3 depicts device 300 that may display a plurality of source objects 312, 314, 316, 318, 320, and 322 that may correspond to a plurality of recent content objects 332, 334, 336, 338, 340, and 342, according to an embodiment of the present disclosure. It should be appreciated that recent content objects 332, 334, 336, 338, 340, and 342 may be content objects that may have originated within a predetermined time frame. As shown in FIG. 3, top source objects 310 may be displayed, and a plurality of top source objects 312, 314, 316, 318 may each list a quantity of recent content objects 332, 334, 336, and 338 that may be available from the corresponding source objects in which the content objects may have been retrieved. For example, source object 312 may include content objects 332, and content objects 332 may include a quantity of 66 content objects. Further, other source objects 350 that may not be top source objects 310 may be displayed on device 300. Similar to the display of top source objects 310, other source objects 350 may be displayed including source objects 320 and 322. Source objects 320 and 322 may each list a quantity of content objects 340 and 342 available from the corresponding source object in which content objects 340 and 342 may have been retrieved. For example, source object 320 may include content objects 340, and content objects 340 may include a quantity of 22 content objects. It should be appreciated a user may create top content providers, top source objects, and/or top content objects without departing from the present disclosure. As shown in FIG. 3, field 360 may be provided and displayed on device 300 so that a user may search all source objects in some embodiments of the present disclosure.

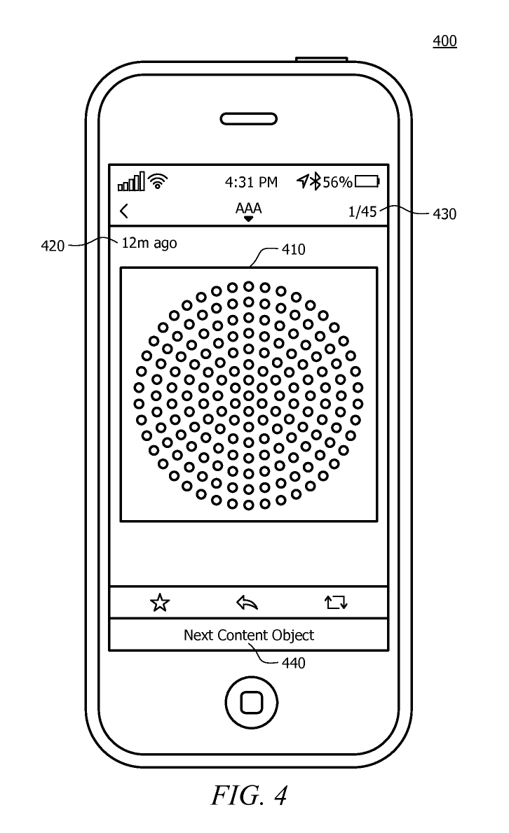

FIG. 4 depicts device 400 that may display single content object 410, according to an embodiment of the present disclosure. As shown in FIG. 4, single content object 410 may be displayed on device 400, and difference 420 between the real time and the origination time of single content object 410 may be displayed. Further, rank 430 of single content object 410 out of total quantity of recent content objects may be displayed. It should be appreciated that button or interface 440 may be provided and displayed on device 400, so that user may display a subsequent single content object in a content set in some embodiments of the present disclosure.

It should be appreciated the user may display more than one content object at a time without departing from the present disclosure. It should be appreciated that the content or substance of each content object may not necessarily be stored on any servers. It should be appreciated a user may manually delete a content object and may access a content object's privacy settings without departing from the present disclosure. It should be appreciated that after a content object may be removed from an application or a website, the content object may never be displayed again in some embodiments of the present disclosure. It should be appreciated that after all content objects may be displayed, a user may reach a stopping point where no content objects may be available. It should be appreciated that a user may take action regarding a content object including, but not limited to, comment on a content object, “favorite” a content object, “retweet” a content object, and/or reply to a content object within a predetermined time frame without departing from the present disclosure.

It should be appreciated a method of displaying a content object and a system for displaying a content object to a user may reduce a user's digital footprint. It should also be appreciated a method of displaying a content object and a system for displaying a content object to a user may provide a simple interface that may not be infinite. As such, the method and system may provide a clutter-free feed of content objects, source objects, and/or content providers. It should be appreciated the method and system of displaying a content object may quickly track content objects for a user that may be “on-the-go” in a distraction-free environment or display. It should be appreciated a user may merge source objects into categories. For example, a user may merge Twitter users who “tweet” sports-related content into a sports category.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method of displaying a content object to a user, the method comprising the steps of:
calculating a difference between a real time and an origination time of the content object, wherein the difference between the real time and the origination time of the content object is continuously calculated;
determining whether the difference between the real time and the origination time is less than a predetermined time frame, wherein when the difference between the real time and the origination time of the content object is greater than or equal to the predetermined time frame, the content object is removed from content objects available for display in an application or on a website;
determining whether the content object was previously viewed, wherein when content object was previously viewed, the content object is removed from the content objects available for display in the application or on the website; and
displaying the content object in the application or on the website when the difference between the real time and the origination time of the content object is less than the predetermined time frame and the content object was not previously viewed.

2. The method of displaying the content object to the user of claim 1, further comprising the steps of:
assigning an identifier to a displayed content object, wherein the identifier is stored in a cache;
calculating a social score for the displayed content object, wherein an unfavorable social score prompts the application or the website to warn the user before the user is permitted to share the displayed content object; and
emptying the cache after the predetermined time frame.

3. The method of displaying the content object to the user of claim 2, further comprising:
detecting an end of a content set after emptying the cache, wherein the content set includes a plurality of content objects; and
returning the user to the step of accessing the content provider from the application or the website.

4. The method of displaying the content object to the user of claim 1, further comprising:
filtering the content object based on filter criteria.

5. The method of displaying the content object to the user of claim 1, further comprising:
clustering the content object based on cluster criteria.

6. The method of displaying the content object to the user of claim 1, further comprising:
sorting and organizing the content object based on criteria specified by the user.

7. A system for displaying a content object to a user, the system comprising:
an application or a website provided to access a content provider;
a source object selected from the content provider;
a content object retrieved from the source object;
a calculation module integrated with a cache, the calculation module provided to continuously calculate a difference between a real time and an origination time of the content object; and
a display module provided to display the content object in the application or on the website when the difference between the real time and the origination time of the content object is less than a predetermined time frame and the content object has not been previously viewed.

8. The system for displaying the content object to the user of claim 7, wherein the cache assigns an identifier to the displayed content object, and wherein the identifier is stored in the cache.

9. The system for displaying the content object to the user of claim 7, wherein the calculation module calculates a social score for the displayed content object, wherein an unfavorable social score prompts the application or the website to warn the user before the user is permitted to share the displayed content object.

10. The system for displaying the content object to the user of claim 7, further comprising:
a content set including a plurality of content objects, wherein the system is provided to empty a cache and detect an end of the content set.

11. The system for displaying the content object to the user of claim 7, further comprising:
a filter module provided to filter the content object based on a filter criteria.

12. The system for displaying the content object to a user of claim 7, further comprising:
a cluster module provided to cluster the content object based on a cluster criteria.

13. The system for displaying the content object to the user of claim 7, further comprising:
a sort and organize module provided to sort and organize the content object based on criteria specified by the user.

14. A non-transitory computer readable medium to execute a process for displaying a content object to a user, the process comprising:
calculating a difference between a real time and an origination time of the content object, wherein the difference between the real time and the origination time of the content object is continuously calculated;
determining whether the difference between the real time and the origination time is less than a predetermined time frame;
determining whether the content object was previously viewed;
displaying the content object in the application or on the website when the difference between the real time and the origination time of the content object is less than the predetermined time frame and the content object was not previously viewed;
assigning an identifier to a displayed content object, wherein the identifier is stored in a cache;
calculating a social score for the displayed content object; and
emptying the cache after the predetermined time frame.
